(19) United States
(12) Patent Application Publication
(10) Pub. No.: US 2016/0092670 A1
(43) Pub. Date: Mar. 31, 2016

(54) Answer Question User Authentication Process

(71) Applicant: Frank Douglas Moseley, Taylors, SC (US)

(72) Inventor: Frank Douglas Moseley, Taylors, SC (US)

(21) Appl. No.: 14/503,375

(22) Filed: Sep. 30, 2014

(51) Int. Cl. G06F 21/40; G06F 21/62

(52) U.S. Cl. CPC G06F 21/40; G06F 21/6245

(57) ABSTRACT

A process of authenticating a person into a computer system as an authorized user by comparing the person's answers to questions that were defined by the authorized user during computer system account creation. The process is analogous to a property security system in that they both use concepts of Gate, Door, Safe, Frisk, and Key. Gate question prevents imposters from entering the computer system. Door question prevents imposters from viewing data should they get past the Gate. Safe question prevents imposters from updating data and viewing confidential data should they get past the Door. Frisk question catches imposters should they enter the computer system by guessing the correct answers to the authorized user's Key, Gate, Door or Safe questions. Key question mitigates imposter brute force attacks by silently locking and unlocking the authorized user account during Gate, Door, Safe, and Frisk questions when the authorized user answers with the Key question instead.

### COMPUTER PROGRAM LISTING

AQUAP.java (standalone Java programming language embodiment)

### BACKGROUND OF THE INVENTION

The password user authentication process is used in most computer systems, not because it is well liked by the users, but because its replacements such as biometric user authentication are liked even less by the users.

Some systems use a single level authentication process where a successful login means the user goes from having no access to having full access. While others use a multiple level authentication process where the user goes from having no access to having read access, and the user must enter another password in order to have write access.

Passwords are easily forgotten, therefore the current trend in computer systems has been to use correctly answered security questions as a signal to send password reset instructions to the email address on file for the account.

Since security questions are so much easier to correctly guess than passwords, and since reading unencrypted emails traveling over the internet is trivial, imposters are finding it far easier to hijack accounts via automated password resets rather than thru password cracking.

Monitor sticky notes, password manager software, and password reset hijacking can all be made obsolete, and computer security and usability could increase if the user authentication process did not have to rely on passwords.

### BRIEF SUMMARY OF THE INVENTION

This summary is provided as a simplified explanation of what is completely described in the detailed description, and this summary is not intended to limit the scope of the claimed subject matter in any way.

All embodiments of this process authenticate a user into the computer system as the authorized user by comparing the answers to the questions defined by the authorized user when they created their account.

All embodiments of this process this use the same terminology as the home security systems that the users are already familiar with.

Gate keeps intruders outside the property.

Gate keeps imposters outside the system.

Door keeps intruders from being in the building.

Door keeps imposters from viewing account data.

Safe keeps intruders from being in the vault.

Safe keeps imposters from changing account data.

Frisk catches intruders inside the property.

Frisk catches imposters inside the system.

Key arms and disarms the alarm.

Key locks and unlocks the account.

### BRIEF DESCRIPTION OF THE DRAWINGS

FIG. 1 is a start processing flow chart.

FIG. 2 is a gate checking flow chart.

FIG. 3 is a door checking flow chart.

FIG. 4 is a safe checking flow chart.

FIG. 5 is a frisk checking flow chart.

FIG. 6 is a lock checking flow chart.

FIG. 7 is an account creation flow chart.

FIG. 8 is an account usage flow chart.

### DETAILED DESCRIPTION OF THE INVENTION

This detail description was designed to be read in conjunction with the flow chart, but the flow chart alone is all that is needed for any competent computer programmer to create any embodiment of the process, including the standalone system embodiment that is included in this patent application.

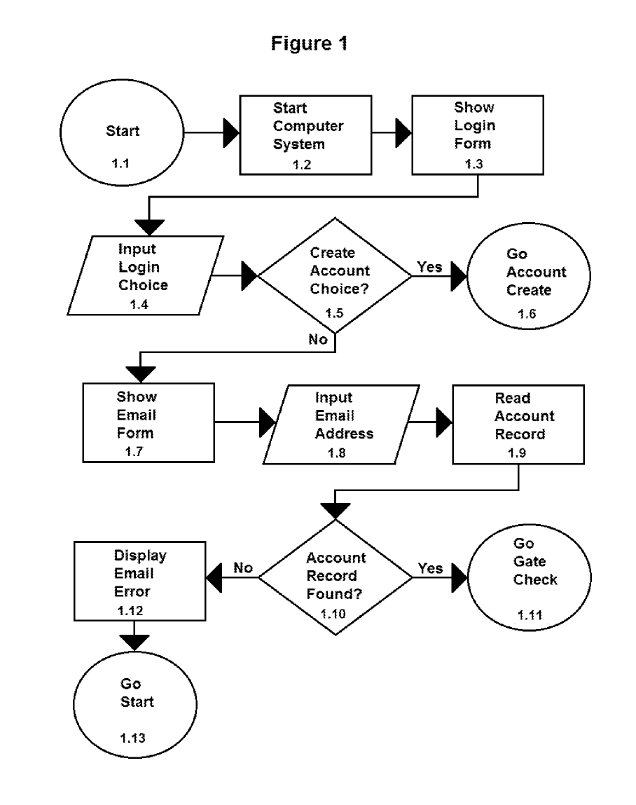

FIG. 1.1=Start represents the providing of the computer system and the user person used in the process.

FIG. 1.2=Start Computer System represents the user starting the standalone system embodiment that is included in this application, by running the AQUAP computer program from the operating system prompt.

FIG. 1.3=Show Login Form represents the system displaying the form where the user decides to either create a new account or to login to an existing account.

FIG. 1.4=Input Login Choice represents the user submitting the form with their decision to either create a new account or to login to an existing account.

FIG. 1.5=Create Account Choice represents the system determining what to do next depending upon what the user decided. Yes means the display the Create form. No means display the Email form.

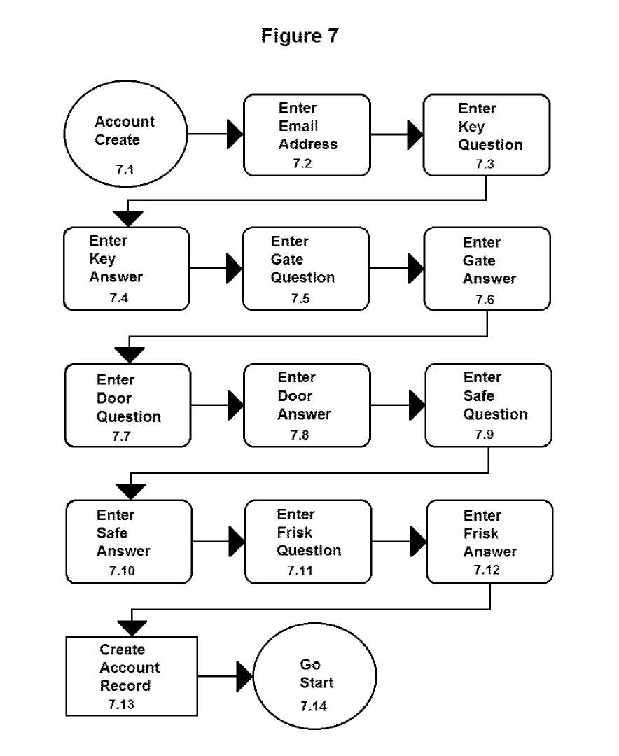

FIG. 1.6=Go Account Create is described in FIG. 7.

FIG. 1.7=Show Email Form represents the system displaying the form where the user enters the email address associated with the account.

FIG. 1.8=Input Email Address represents the user submitting the form with the email address.

FIG. 1.9=Read Account Record represents the system using the input email address to find an account record.

FIG. 1.10=Account Record Found represents the system determining what to do next depending upon whether or not the record was found. Yes means display the Gate form. No means display the Email error message.

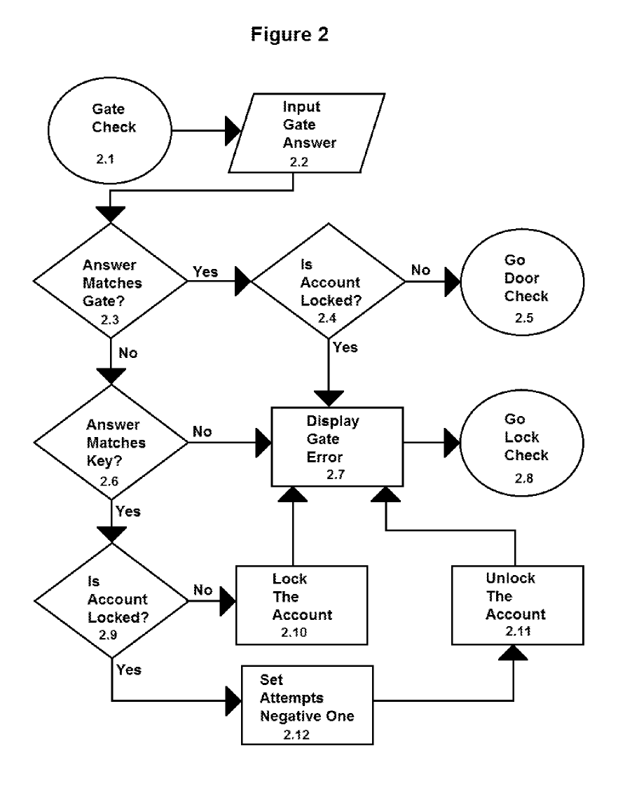

FIG. 1.11=Go Gate Check is described in FIG. 2.

FIG. 1.12=Display Email Error represents the system displaying and error message.

FIG. 1.13=Go Start is described in FIG. 1.

FIG. 2.1=Gate Check represents the system displaying the form where the user answers the Gate question.

FIG. 2.2=Input Gate Answer represents the user submitting the form with either the Gate answer or the Key answer depending upon whether or not the user wants to silently lock or unlock the account.

FIG. 2.3=Answer Matches Gate represents the system determining what to do next depending upon what the user answered. Yes means check if account is locked. No means check if answer matches Key.

FIG. 2.4=Is Account Locked represents the system determining what to do next depending upon whether or not the account is locked. Yes means display error. No means display Door form.

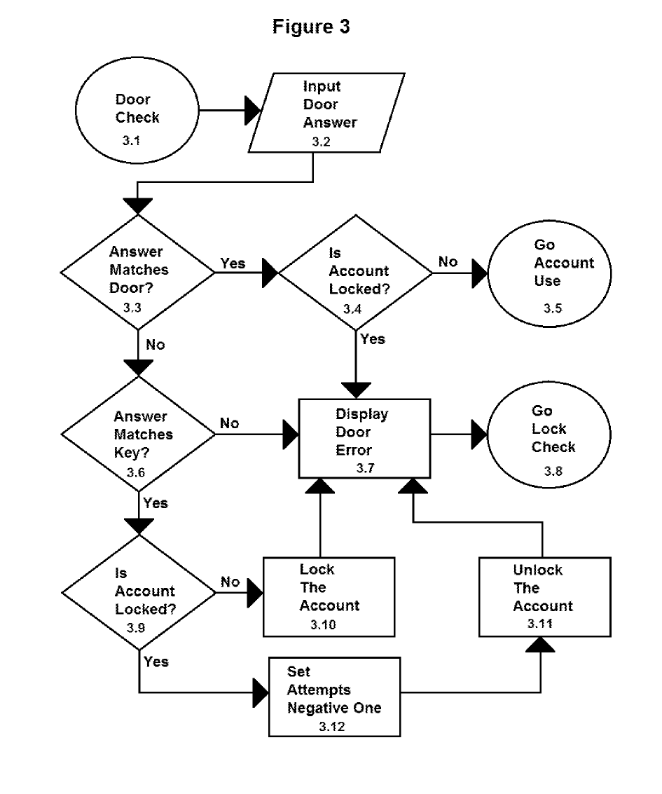

FIG. 2.5=Go Door Check is described in FIG. 3.

FIG. 2.6=Answer Matches Key represents the system determining what to do next depending upon what the user answered. Yes means check if account is locked. No means display Gate error message.

FIG. 2.7=Display Gate Error represents the system displaying an error message.

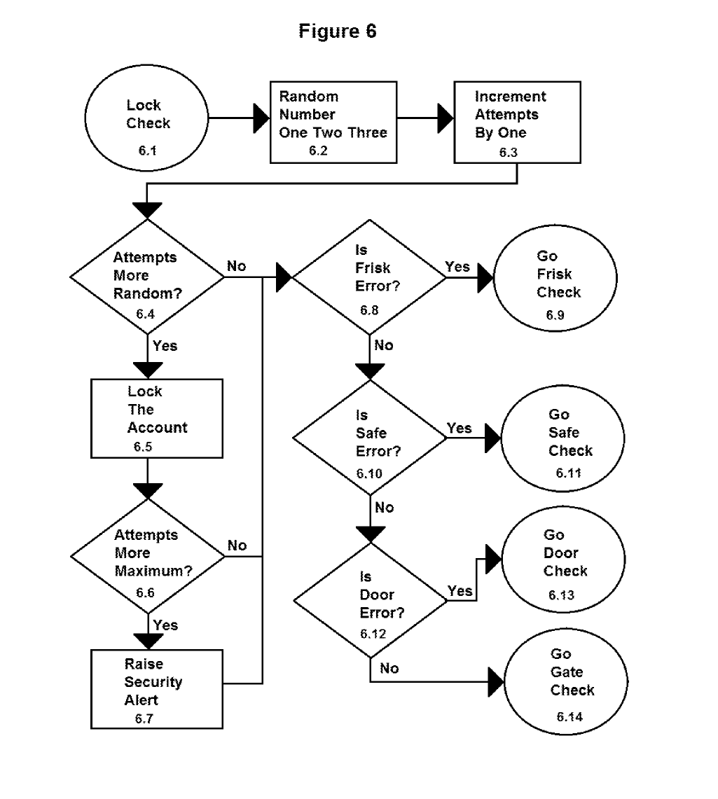

FIG. 2.8=Go Lock Check is described in FIG. 6.

FIG. 2.9=Is Account Locked represents the system determining what to do next depending upon whether or not the account is locked. Yes means silently unlock the account. No means silently lock the account.

FIG. 2.10=Lock The Account represents the system silently locking the account which means that the forms will start rejecting correct answers and start displaying error messages.

FIG. 2.11=Unlock The Account represents the system silently unlocking the account which means that the forms will stop rejecting correct answers and stop displaying error messages.

FIG. 2.12=Set Attempts −1 represents the system resetting the number of attempts counter. The system did not reset to zero because the account unlocking counts as one more attempt towards the limit, since technically it is the wrong answer to the question.

FIG. 3.1=Door Check represents the system displaying the form where the user answers the Door question.

FIG. 3.2=Input Door Answer represents the user submitting the form with either the Door answer or the Key answer depending upon whether or not the user wants to silently lock or unlock the account.

FIG. 3.3=Answer Matches Door represents the system determining what to do next depending upon what the user answered. Yes means check if account is locked. No means check if answer matches Key.

FIG. 3.4=Is Account Locked represents the system determining what to do next depending upon whether or not the account is locked. Yes means display error. No means display Use form.

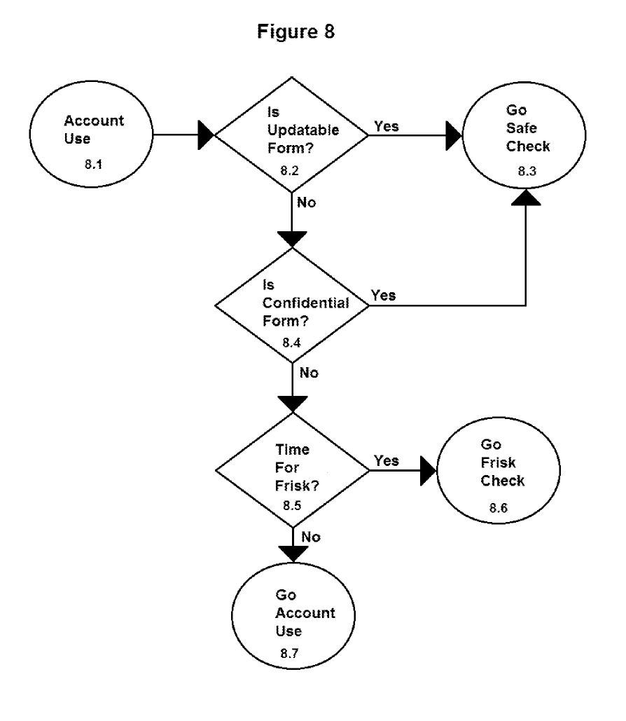

FIG. 3.5=Go Account Use is described in FIG. 8.

FIG. 3.6=Answer Matches Key represents the system determining what to do next depending upon what the user answered. Yes means check if account is locked. No means display Door error message.

FIG. 3.7=Display Door Error represents the system displaying and error message.

FIG. 3.8=Go Lock Check is described in FIG. 6.

FIG. 3.9=Is Account Locked represents the system determining what to do next depending upon whether or not the account is locked. Yes means silently unlock the account. No means silently lock the account.

FIG. 3.10=Lock The Account represents the system silently locking the account which means that the forms will start rejecting correct answers and start displaying error messages.

FIG. 3.11=Unlock The Account represents the system silently unlocking the account which means that the forms will stop rejecting correct answers and stop displaying error messages.

FIG. 3.12=Set Attempts −1 represents the system resetting the number of attempts counter. The system did not reset to zero because the account unlocking counts as one more attempt towards the limit, since technically it is the wrong answer to the question asked.

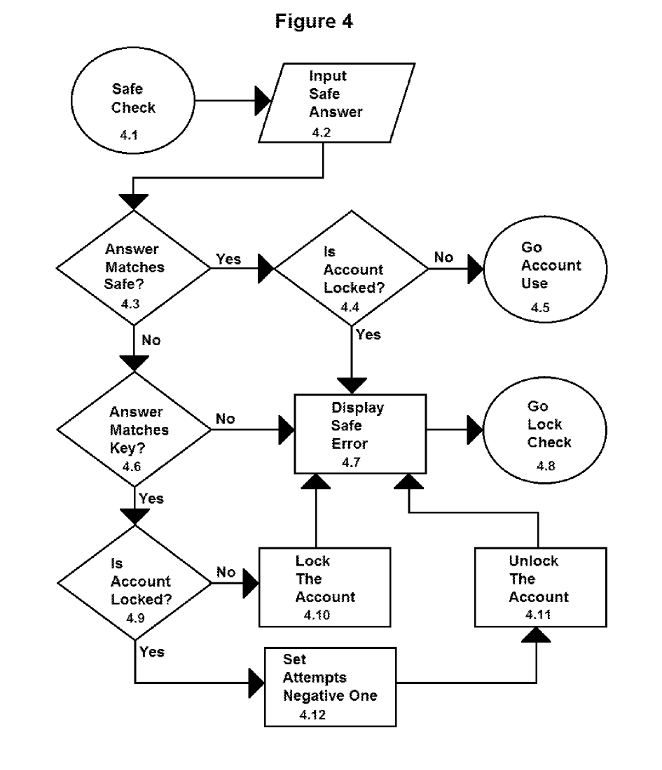

FIG. 4.1=Safe Check represents the system displaying the form where the user answers the Safe question.

FIG. 4.2=Input Safe Answer represents the user submitting the form with either the Safe answer or the Key answer depending upon whether or not the user wants to silently lock or unlock the account.

FIG. 4.3=Answer Matches Safe represents the system determining what to do next depending upon what the user answered. Yes means check if account is locked. No means check if answer matches Key.

FIG. 4.4=Is Account Locked represents the system determining what to do next depending upon whether or not the account is locked. Yes means display error. No means display Use Form.

FIG. 4.5=Go Account Use is described in FIG. 8.

FIG. 4.6=Answer Matches Key represents the system determining what to do next depending upon what the user answered. Yes means check if account is locked. No means display Safe error message.

FIG. 4.7=Display Safe Error represents the system displaying and error message.

FIG. 4.8=Go Lock Check is described in FIG. 6.

FIG. 4.9=Is Account Locked represents the system determining what to do next depending upon whether or not the account is locked. Yes means silently unlock the account. No means silently lock the account.

FIG. 4.10=Lock The Account represents the system silently locking the account which means that the forms will start rejecting correct answers and start displaying error messages.

FIG. 4.11=Unlock The Account represents the system silently unlocking the account which means that the forms will stop rejecting correct answers and stop displaying error messages.

FIG. 4.12=Set Attempts −1 represents the system resetting the number of attempts counter. The system did not reset to zero because the account unlocking counts as one more attempt towards the limit, since technically it is the wrong answer to the question asked.

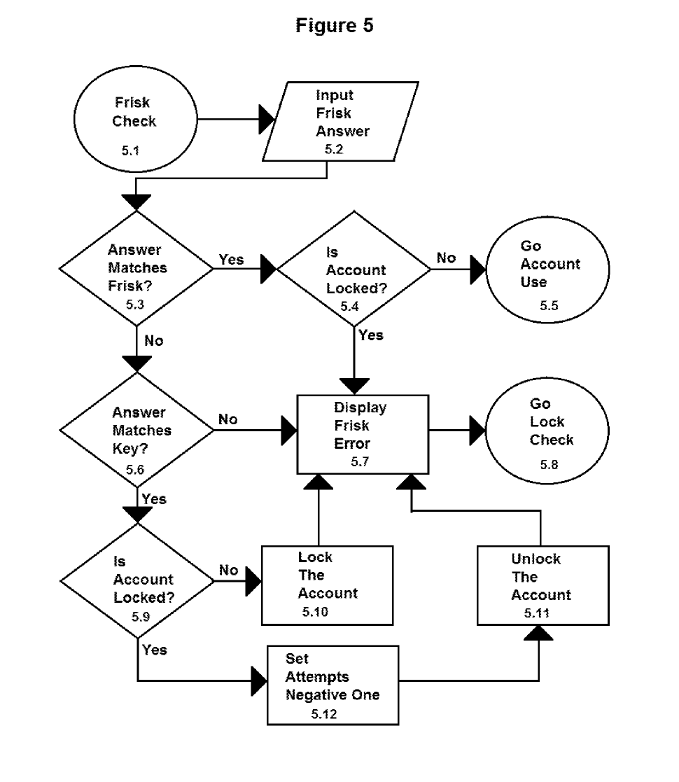

FIG. 5.1=Frisk Check represents the system displaying the form where the user answers the Frisk question.

FIG. 5.2=Input Frisk Answer represents the user submitting the form with either the Frisk answer or the Key answer depending upon whether or not the user wants to silently lock or unlock the account.

FIG. 5.3=Answer Matches Frisk represents the system determining what to do next depending upon what the user answered. Yes means check if account is locked. No means check if answer matches Key.

FIG. 5.4=Is Account Locked represents the system determining what to do next depending upon whether or not the account is locked. Yes means display error. No means display Use form.

FIG. 5.5=Go Account Use is described in FIG. 8.

FIG. 5.6=Answer Matches Key represents the system determining what to do next depending upon what the user answered. Yes means check if account is locked. No means display Frisk error message.

FIG. 5.7=Display Frisk Error represents the system displaying and error message.

FIG. 5.8=Go Lock Check is described in FIG. 6.

FIG. 5.9=Is Account Locked represents the system determining what to do next depending upon whether or not the account is locked. Yes means silently unlock the account. No means silently lock the account.

FIG. 5.10=Lock The Account represents the system silently locking the account which means that the forms will start rejecting correct answers and start displaying error messages.

FIG. 5.11=Unlock The Account represents the system silently unlocking the account which means that the forms will stop rejecting correct answers and stop displaying error messages.

FIG. 5.12=Set Attempts −1 represents the system resetting the number of attempts counter. The system did not reset to zero because the account unlocking counts as one more attempt towards the limit, since technically it is the wrong answer to the question asked.

FIG. 6.1=Lock Check represents the system determining whether or not the account needs to be locked because of too many incorrect attempts.

FIG. 6.2=Random Number represents the system generating a random limit of 1 or 2 or 3 to determine the limit needed to lock the account.

FIG. 6.3=Increase Attempts +1 represents the system incrementing the number of incorrect attempts.

FIG. 6.4=Answer More Random represents the system determining what to do next depending upon whether the attempts are more than the random number. Yes means lock the account. No means return back to the form.

FIG. 6.5=Lock The Account represents the system silently locking the account which means that the forms will start rejecting correct answers and start displaying error messages.

FIG. 6.6=Answer More Maximum represents the system determining what to do next depending upon whether the attempts are more than the absolute maximum allowed. Yes means raise security alert. No means return back to the form.

FIG. 6.7=Raise Security Alert represents the system notifying the administrators that the account is under brute force attack.

FIG. 6.8=Is Frisk Error represents the system determining what to do next depending upon whether or not the error is from the Frisk answer. Yes means return to Frisk form. No means check if error is from the Safe form.

FIG. 6.9=Go Frisk Check is described in FIG. 5.

FIG. 6.10=Is Safe Error represents the system determining what to do next depending upon whether or not the error is from the Safe answer. Yes means return to Safe form. No means check if error is from the Door form.

FIG. 6.11=Go Safe Check is described in FIG. 4.

FIG. 6.12=Is Door Error represents the system determining what to do next depending upon whether or not the error is from the Door answer. Yes means return to Door form. No means return to Gate form.

FIG. 6.13=Go Door Check is described in FIG. 3.

FIG. 6.14=Go Gate Check is described in FIG. 2.

FIG. 7.1=Account Create represents the system displaying the form where the user creates a new account.

Questions can be any number of lowercase words and each word can contain any number of letters.

Answers must be two and only two lowercase words and each word must contain at least three letters.

More than two words make remembering too hard.

Less than two words make guessing too easy.

Less than three letters make guessing too easy.

FIG. 7.2 Enter Email Address represents the user submitting the form with their choice of Email Address.

FIG. 7.3 Enter Key Question represents the user submitting the form with their choice of Key Question.

FIG. 7.4 Enter Key Answer represents the user submitting the form with their choice of Key Answer.

FIG. 7.5 Enter Gate Question represents the user submitting the form with their choice of Gate Question.

FIG. 7.6 Enter Gate Answer represents the user submitting the form with their choice of Gate Answer.

FIG. 7.7 Enter Door Question represents the user submitting the form with their choice of Door Question.

FIG. 7.8 Enter Door Answer represents the user submitting the form with their choice of Door Answer.

FIG. 7.9 Enter Safe Question represents the user submitting the form with their choice of Key Safe.

FIG. 7.10 Enter Safe Answer represents the user submitting the form with their choice of Safe Answer.

FIG. 7.11 Enter Frisk Question represents the user submitting the form with their choice of Frisk Question.

FIG. 7.12 Enter Frisk Answer represents the user submitting the form with their choice of Frisk Answer.

FIG. 7.13 Create Account Record represents the system creating an account record containing the data entered.

FIG. 7.14=Go Start is described in FIG. 1.

FIG. 8.1=Account Use represents the system displaying the forms where the user uses their account to access data in the computer system.

FIG. 8.2=Is Updatable Form represents the system determining what to do next depending upon whether or not the form is updatable. Yes means show the Safe form. No means check if form is confidential.

FIG. 8.3=Go Safe Check is described in FIG. 4.

FIG. 8.4=Is Confidential Form represents the system determining what to do next depending upon whether or not the form is confidential. Yes means show the Safe form. No means check if time for Frisk.

FIG. 8.5=Time For Frisk represents the system determining what to do next depending upon whether or not the maximum amount of time since the last Frisk has passed. Yes means show the Frisk form. No means display to the form that the user wants to use.

FIG. 8.6=Go Frisk Check is described in FIG. 5.

FIG. 8.7=Go Account Use is described in FIG. 8.

From this detailed description the advantages of answer question authentication over password authentication are evident.

Authorized users will find it far easier to remember the answers to questions that jog their mind than it is to remember complex passwords.

Unauthorized imposters will find it far harder to hijack authorized user accounts because of the lack of password resets and the silent account locking and unlocking which makes brute force attacks far less likely to succeed, since both the Key and Gate questions must both be guessed together within just three attempts of each other.

Although the claimed subject matter in this detailed description applies to all embodiments and has used general language as much as possible, it is to be understood that any specific language was only used for the purposes of facilitating greater understanding and is not intended to limit the claimed subject matter.

The claimed subject matter may be implemented by any competent computer programmer using standard computer programming techniques to produce software, firmware, hardware, or any combination thereof to control a computer to implement the disclosed subject matter.

1. A process of authenticating a person into a tied computer system as an authorized user by comparing said person's answers to questions that were defined by the authorized user during computer system account creation, comprising:
a. enabling said computer system to authenticate said person as the authorized user and letting them in, while at the same time rejecting unauthorized imposters and keeping them out;
b. enabling said person to become an authorized user by creating an account record;
c. creating said account record from email address, key question key answer, gate question, gate answer, door question, door answer, safe question, safe answer, frisk question, and frisk answer input by said authorized user;
d. enabling said authorized user to login to said computer system by entering their email address, silently unlocking their account by answering the gate question with the correct key answer, answering the gate question with the correct answer, and answering the door question with the correct answer;
e. enabling said computer system to require that said authorized user correctly answer the safe question when updating any data or when viewing confidential data, and to be locked out of their account should they answer incorrectly;
f. enabling said computer system to require that said authorized user correctly answer the frisk question when the maximum amount of time has passed since the last frisk, and to be locked out of their account should they answer incorrectly.
